(19) United States
(12) Patent Application Publication
(10) Pub. No.: US 2007/0139182 A1
(43) Pub. Date: Jun. 21, 2007

(54) Emergency communications for the mobile environment

(76) Inventors: Jay D. O'Connor, Chicago, IL (US); Ramy P. Ayoub, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/313,115

(22) Filed: Dec. 19, 2005

(51) Int. Cl. G08B 19/00; G08B 1/08

(52) U.S. Cl. 340/521; 340/539.22

(57) ABSTRACT

Systems and methods for two-way, interactive communication regarding emergency notifications and responses for mobile environments are disclosed. In accordance with one embodiment of the present invention, a specific geographic area is designated for selective emergency communications. The emergency communications may comprise text, audio, video, and other types of data. The emergency notification is sent to users' mobile communications devices such as in-vehicle telematics units, cellular phones, personal digital assistants (PDAs), laptops, etc. that are currently located in the designated area. The sender of the emergency message or the users' service provider(s) may remotely control cameras and microphones associated with the users' mobile communications devices. For example, a rear camera ordinarily used when driving in reverse may be used to capture images and video that may assist authorities in searching for a suspect. The users' vehicles may send photographs or video streams of nearby individuals, cars and license plates, along with real-time location information, in response to the emergency notification. Image recognition algorithms may be used to analyze license plates, vehicles, and faces captured by the users' cameras and determine whether they match a suspect's description. Advantageously, the present invention utilizes dormant resources in a highly beneficial and time-saving manner that increases public safety and national security.

### FIELD OF THE INVENTION

The present invention is generally related to the field of wireless telecommunications, and more particularly to systems and methods for providing two-way communications with mobile devices regarding emergency notifications and responses.

### BACKGROUND OF THE INVENTION

The Emergency Broadcast System (EBS) is an emergency warning system used in the United States to broadcast emergency messages via radio and television. The EBS has been replaced with the Emergency Alert System (EAS), which is used by the President of the United States and others to warn the public about emergency situations via radio, television, and cable television. The Department of Homeland Security (DHS) manages emergency responses to terrorist attacks, natural disasters, and other large-scale emergencies. The Federal Emergency Management Administration (FEMA) is part of the DHS and provides direction for state and local emergency planning officials to plan and implement their roles in the EAS. The National Weather Service (NWS) provides emergency weather information used to alert the public of dangerous conditions.

America's Missing: Broadcast Emergency Response (AMBER) Alerts are emergency messages broadcast when a law enforcement agency determines that a child has been abducted and is in imminent danger. AMBER Alerts are disseminated through such channels as broadcast radio and television stations, cable outlets, newspapers, and road signs.

The Wireless AMBER Alerts Initiative is an effort to distribute AMBER Alerts to wireless subscribers who opt in to receive the messages and are able to receive text messages on their wireless devices. When subscribers opt in, they provide their wireless phone numbers and designate up to five zip codes for which they wish to receive Wireless AMBER Alerts. Participating wireless carriers send AMBER Alert text messages pertaining to specified zip codes to their subscribers who have opted in to receive the notices for those zip codes.

Prior emergency systems suffer from a number of drawbacks. For example, they are limited in that they only provide one-way communication. That is, they broadcast emergency information to members of the public without providing a means to receive emergency-related information from members of the public in response. In emergency situations, however, members of the general public are often well-positioned to assist governmental agencies and authorities. Accordingly, a one-way emergency notification system fails to take advantage of the features and capabilities of telecommunications devices used by the general public as a resource for resolving an emergency situation.

In addition, the prior art methods of disseminating information have lacked effectiveness. Certain emergency alerts are broadcast over the public airwaves, but still only reach a small percentage of the population. Furthermore, some public safety systems depend on road signs to alert vehicle drivers of public safety issues, such as AMBER Alerts. These signs are not available everywhere and their use is a cumbersome means of selectively reaching vehicles in limited areas.

Thus, a need has therefore arisen for an improved emergency notification system that overcomes the deficiencies in the prior art.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 depicts a block diagram of an exemplary system for emergency communications in accordance with one embodiment of the present invention;

FIG. 2 depicts a sequence diagram for an exemplary method for providing emergency communications in accordance with one embodiment of the present invention;

FIG. 3 depicts a sequence diagram for an exemplary method for providing emergency communications in accordance with another embodiment of the present invention; and

FIG. 4 depicts a sequence diagram for an exemplary method for providing emergency communications in accordance with another embodiment of the present invention.

### DETAILED DESCRIPTION OF THE INVENTION

The present invention provides for systems and methods for two-way, interactive communication regarding emergency notifications and responses for mobile environments. In accordance with one embodiment of the present invention, a specific geographic area is designated for selective emergency communications. The emergency communications may comprise text, audio, video, and other types of data. The emergency notification is sent to users' mobile communications devices such as in-vehicle telematics units, mobile telephones, personal digital assistants (PDAs), and laptops, etc. that are currently located in the designated area. This may be accomplished by automatically sending the emergency notification to the phone numbers of selected mobile communications devices whose Global Positioning System (GPS) locations are within the designated area. Alternatively, the emergency notification may be broadcast to selected vehicles and mobile communications devices within range of selected base stations in the designated area.

The sender of the emergency message or the users' service provider(s) may remotely control input devices, such as cameras and microphones, associated with the users' mobile communications devices in the designated area. For example, a rear camera ordinarily used when driving in reverse may be used to capture images and video that may assist authorities in searching for a suspect or a missing person. The users' vehicles may send audio, photographs or video streams of nearby individuals, cars and license plates, along with real-time location information, in response to the emergency notification. Image recognition algorithms may be used to analyze license plates, vehicles, and faces captured by the users' cameras and determine whether they match a profile or description of a suspect or missing person. Voice recognition algorithms may be used to analyze audio information and determine if a match is found relative to a suspect or a missing person. Advantageously, the present invention utilizes dormant resources in a highly beneficial and time-saving manner that increases public safety and national security.

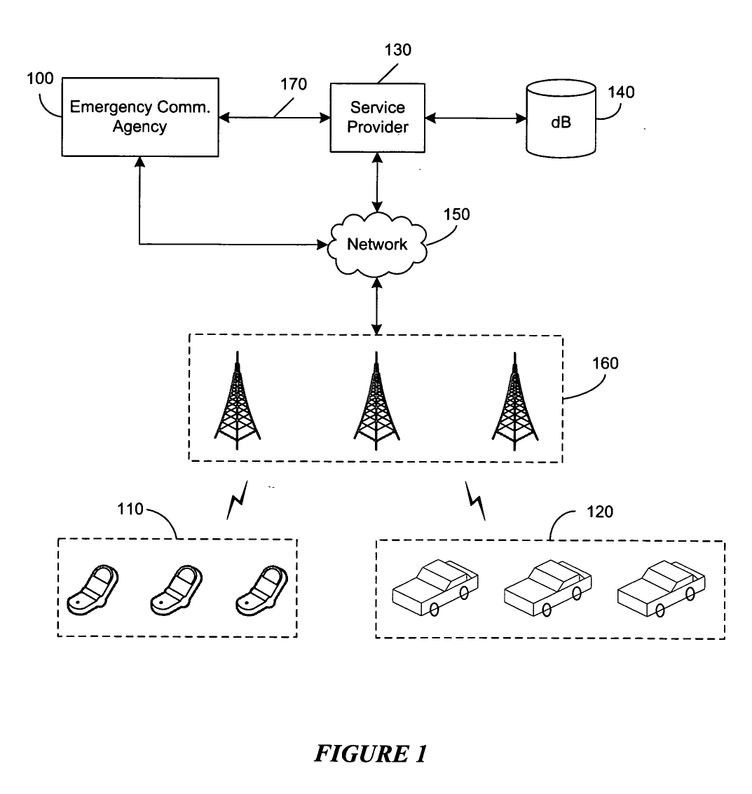

Reference is now made to FIG. 1, which depicts a block diagram of an exemplary system for emergency communications in accordance with one embodiment of the present invention. The system comprises one or more emergency communication agencies 100. A few examples of such agencies and authorities include DHS, FEMA, NWS, police departments, and fire departments, etc.

In the example shown in FIG. 1, communications with the subscriber devices such as mobile devices 110 and vehicles 120 are handled by the service provider 130. The service provider 130 performs telephony switching functions, controls wireless calls, tracks billing information, and locates wireless subscribers. The service provider 130 may be communicably coupled to one or more databases 140 containing up-to-date information concerning the locations and subscription profiles for the service provider's users. In a GSM network, for example, the database may comprise a Visitor Location Register (VLR) or a Home Location Register (HLR).

The one or more emergency communication agencies 100 request information, typically from a database 140 of the service provider(s) 130. A few examples of such service providers are Telematics service providers, real-time navigation service providers, satellite radio service providers, as well as government agencies and public agencies. The request for information may include a request for addresses (including phone numbers) and capabilities of all subscriber devices located in a specified geographic area. The request may be communicated via a public network 150, or via a secure link 170 directly to the service provider 130.

As shown in FIG. 1, the subscriber devices include mobile devices 110 and vehicles 120. Each of the vehicles 120 comprises an in-vehicle telematics unit including a Telematics Control Unit (TCU) that sends and receives signals to and from the service provider 130. The TCU may comprise or be coupled to additional components, such as a transceiver, a GPS receiver, a modem, a camera, a microphone, a speaker, a handset, a controller, and software running on the controller. For example, the vehicles 120 may include one or more cameras and one or more microphones, coupled to the TCU. Such cameras and microphones may be located inside the vehicle 120, or may be outside the vehicle, or both.

The mobile devices 110 may include any of a variety of subscriber devices, such as mobile telephones, PDAs, laptops, and other devices capable of two-way wireless communication. Each mobile device 110 may typically comprise such components as a transceiver, a GPS receiver, a modem, a camera, a microphone, a speaker, a controller, and software running on the controller. The mobile devices 110 send and receive data, which may comprise audio, video, text, or other data, via the network 150.

The network 150 may comprise, for example, a cellular network, a Public Switched Telephone Network (PSTN), a data network (such as an IP-based network, a satellite network, or a Dedicated Short Range Communication (DSRC) network, etc.), or a combination thereof. Satellite service providers, for example, are installing two-way communication links to their subscribers to provide them with greater flexibility in selecting their entertainment and applications. Inherent in this ability is the ability to retrieve data from the subscribers for purposes of emergency crisis management. Currently, 802.11 communication links to the mobile devices 110 and vehicles 120 are being provided by systems such as DSRC. DSRC systems are operable in the 5.9 GHz band and are developed to support a wide range of public-safety and private operations in roadside-to-vehicle and vehicle-to-vehicle environments for the transportation industry. DSRC complements cellular communications, where time-critical responses (e.g., less than 50 ms) or substantially high data transfer rates (e.g., 6-54 Mbps) are needed in small zones with license-protected authority, and enables a new class of communications applications that can support future transportation systems and needs.

The transceiver of the mobile devices 110 and vehicles 120 may operate according to an analog wireless communication protocol such as the Advanced Mobile Phone System (AMPS). In addition, the transceiver may operate according to a digital wireless communication protocol such as a Code Division Multiple Access (CDMA) protocol or a Time Division Multiple Access (TDMA) protocol. Moreover, the transceiver may operate according to any of several types of bearer services to transmit data to and from a remote station, such as Global System for Mobile Communications (GSM), Universal Mobile Telecommunications Service (UMTS), General Packet Radio Service (GPRS), Enhanced Data rate for GSM Evolution (EDGE), Personal Communications Service (PCS), Wireless Application Protocol (WAP), Wi-Fi®, Worldwide Interoperability for Microwave Access (WiMAX), Short Message Service (SMS), Multimedia Messaging Service (MMS), Circuit Switched Data Service (CSD), High-Speed Circuit Switched Data Service (HSCSD), Satellite Radio (SR), DSRC, or other wireless communication service.

The service provider 130 is communicably coupled to a plurality of Base Transceiver Stations (BTSs) 160 via the network 150. The BTSs comprise the radio equipment (e.g., transceivers and antennas) that handle the radio interface to the mobile devices 110 and vehicles 120. A number of repeaters may also be used to amplify, reshape, or retime signals. A BTS may include equipment for different service providers.

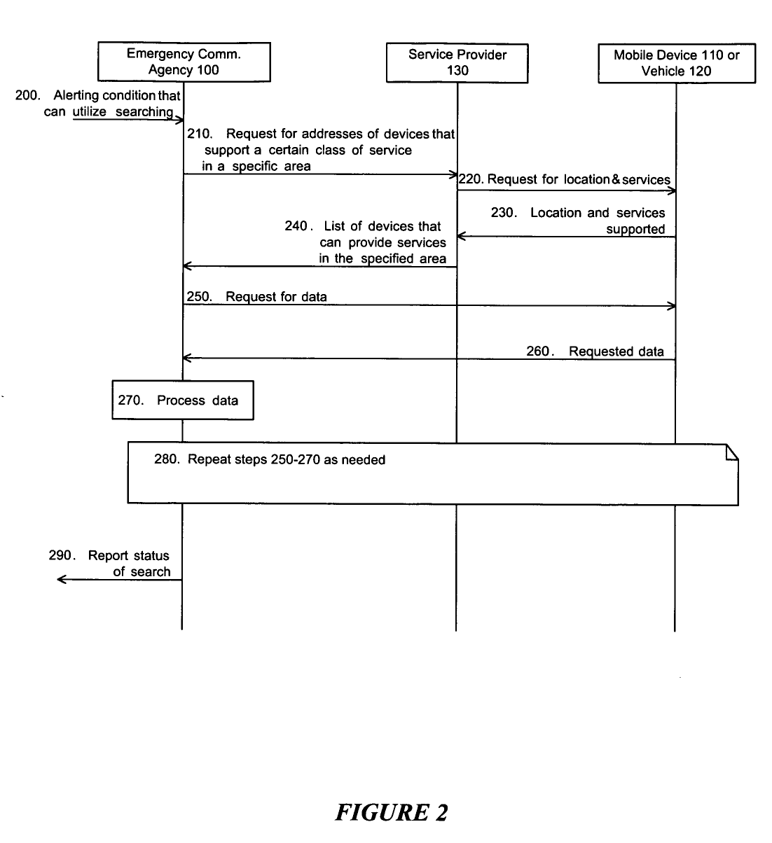

Reference is now made to FIG. 2, which depicts a sequence diagram for an exemplary method for providing emergency communications utilizing the system of FIG. 1. Initially, the emergency communication agency 100 receives a notification of an emergency condition. For example, a Public Safety Answering Point (PSAP) may receive a 911 emergency call reporting of an abducted child. It will be appreciated by those of ordinary skill in the art that in addition to AMBER Alerts, the present invention may be used in connection with various other types of emergency conditions, such as emergency weather conditions, natural disasters, terrorist attacks, etc.

The emergency communication agency 100 sends a request to one or more service providers 130 for addresses of mobile devices 110 and vehicles 120 that are currently located in a specified area. For example, the request may comprise a request for all mobile devices 110 and vehicles 120 located in one or more specified cities. In addition, the request may be limited to mobile devices 110 and vehicles 120 that are capable of supporting a specified class of service. For example, the request may comprise a request for all mobile devices 110 and vehicles 120 that are located in one or more specified cities and that support camera functionality. In addition, the request may be limited to mobile devices 110 and vehicles 120 that support capabilities and standards such as SMS, MMS, Wi-Fi®, Radio Data System (RDS), or two-way video. Moreover, the request may be limited to mobile devices 110 and vehicles 120 that have opted in to receiving emergency notifications and/or sending emergency responses.

Next, the service provider 130 determines which mobile devices 110 and vehicles 120 are in the area(s) of interest. This may be accomplished, for example, by querying a database for all subscribers currently located in the area(s) of interest, or by determining the GPS location for each mobile device 110 or vehicle 120. In addition, the service provider 130 may determine which of the mobile devices 110 and vehicles 120 support the specified class of service. This may be accomplished, for example, by retrieving subscriber profile information from the database.

The service provider 130 sends a response to the emergency communication agency 100. The response comprises information pertaining to the mobile devices 110 and vehicles 120 that match the emergency communication agency 100's criteria (e.g., location and supported services).

The emergency communication agency 100 sends an emergency notification to each of the mobile devices 110 and vehicles 120 that meet its criteria. Alternatively, the emergency communication agency 100 may send the emergency notification to only some of the mobile devices 110 and vehicles 120 that meet its criteria. The sending of the emergency notification may be accomplished by using an automated calling system to call each phone number associated with the selected mobile devices 110 and vehicles 120. A more detailed description of an automated calling system may be found in U.S. Pat. No. 5,559,867 entitled “Automated Calling System with Database Updating,” the contents of which are hereby incorporated by reference.

In addition, the emergency communication agency 100 may send a request to the mobile devices 110 and vehicles 120 for information. A response comprising the requested information is sent from the mobile device 110 or vehicle 120 to the emergency communication agency 100. The response may comprise, for example, audio, video, and/or images of nearby vehicles and individuals as captured by one or more media input devices such as microphones and/or cameras associated with the mobile device 110 or vehicle 120. The response may further comprise information pertaining to the current location of the mobile device 110 or vehicle 120, such as its GPS location.

The above-described steps may be repeated periodically, as mobile devices 110 and vehicles 120 may continually enter and leave the area(s) of interest. A report on the status of the search may be sent from the emergency communication agency 100 to another agency or authority for review and action.

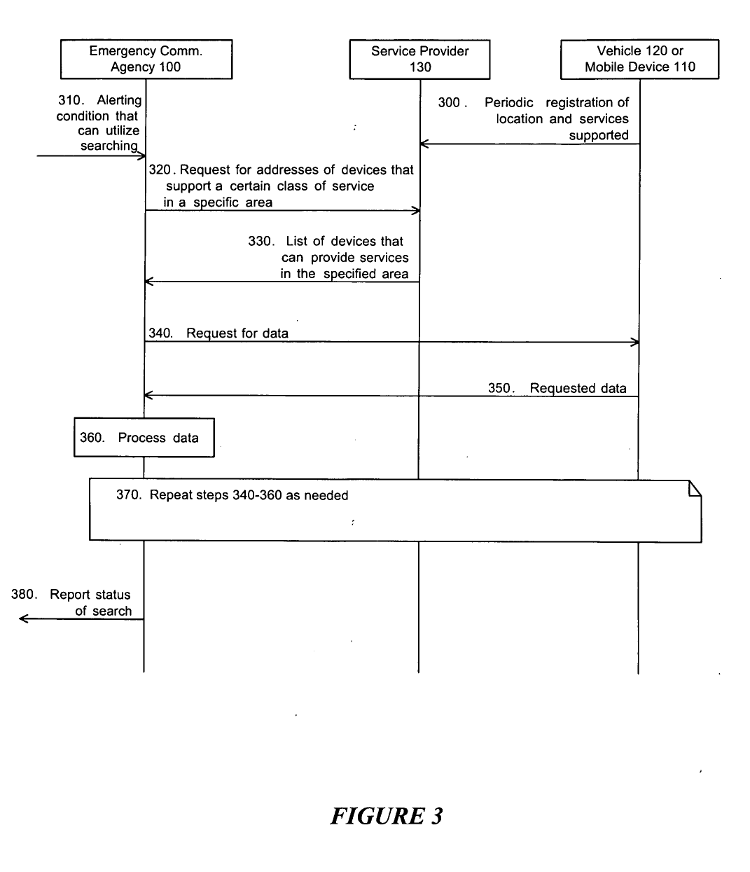

Reference is now made to FIG. 3, which depicts a sequence diagram for another exemplary method for providing emergency communications utilizing the system of FIG. 1. The vehicles 120 and mobile devices 110 periodically register their locations and services supported with the service provider 130. The location information and services supported may be stored in a database, such as a VLR or HLR.

The emergency communication agency 100 receives a notification of an emergency condition. The emergency communication agency 100 sends a request to one or more service providers 130 for addresses of mobile devices 110 and vehicles 120 that are currently located in a specified area or areas.

Next, the service provider 130 sends a response to the emergency communication agency 100. The response comprises information pertaining to the mobile devices 110 and vehicles 120 that match the emergency communication agency 100's criteria (e.g., location and supported services), based on information stored in the database.

The emergency communication agency 100 sends an emergency notification to each of the vehicles 120 and/or mobile devices 110 that meet its criteria as identified by the service provider 130. This may be accomplished, for example, by identifying all base stations within the area of interest and selectively transmitting the emergency notification to vehicles 120 and/or mobile devices 110 within range of those base stations, or a selected number of such base stations. The broadcast radius or direction may be varied by modifying the power and communications parameters (e.g., gain, db, etc.)

In addition, the emergency communication agency 100 sends a request to one or more of the vehicles 120 and mobile devices 110. The request may comprise control data for controlling one or more microphones, cameras, or other devices associated with the vehicles 120 or mobile devices 110, and a request for information. In the context of vehicles 120, the camera is communicably coupled to the vehicle's TCU via a bus. In the context of mobile devices 110 such as cellular telephones, the camera is typically integrated into a handset. The camera may be remotely controlled, for example, by retrieving the camera's IP address and sending instructions for powering the camera on or off, and for adjusting the camera direction, zoom, pan, tilt, and other control parameters. The camera may be remotely controlled by the emergency communication agency 100 or by the service provider 130. The camera may capture video or images of nearby vehicles and individuals, etc.

The requested information is sent from the vehicle 120 or mobile device 110 to the emergency communication agency 100, which information may comprise the captured audio, video, images, or other information. For example, the response may further comprise information pertaining to the current location of the vehicle 120 or mobile device 110. The subscriber's consent to send the information may be required.

The above-described steps may be repeated periodically, as vehicles 120 and mobile devices 110 are mobile and may continually enter and leave the location of interest. A report on the status of the search may be sent from the emergency communication agency 100 to another agency or authority for review and action.

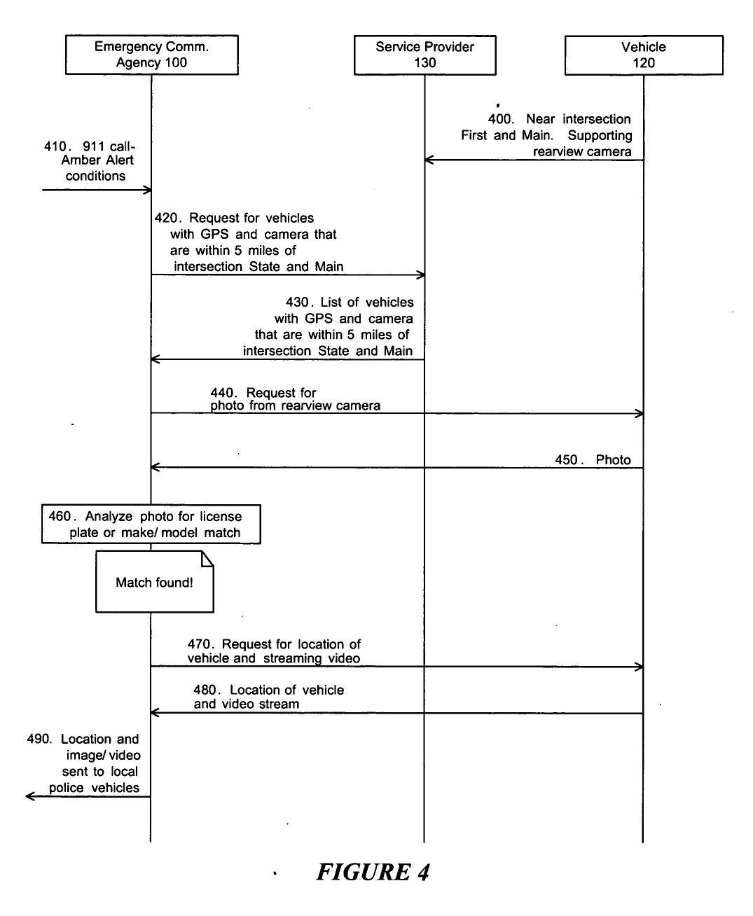

FIG. 4 depicts a sequence diagram of a more detailed example of a method for providing emergency communications utilizing the system of FIG. 1. A plurality of vehicles 120 periodically register their locations and services supported with the service provider 130. In the example of FIG. 4, the location of a particular vehicle 120 is currently near the intersection of First Street and Main Street. Rearview camera services are supported by the vehicle 120. GPS services are also supported by the vehicle 120. Such information may be stored in a database of the service provider 130.

The emergency communication agency 100 receives a notification of an emergency condition. In the example of FIG. 4, the emergency condition involves an abducted child in imminent danger as reported in a 911 emergency call received by a PSAP. The circumstances are deemed by authorities to be appropriate for an AMBER Alert.

The emergency communication agency 100, which may be the PSAP in this example, sends a request to one or more service providers 130 for addresses of vehicles 120 that are currently located within five miles of the intersection of State and Main and that support GPS and camera services. In response, each service provider 130 queries the appropriate database(s) and sends a list of vehicles 120 that meet the criteria specified in the request. The particular vehicle 120 described above which is located at First and Main meets the specified criteria and is identified in the response.

Next, the emergency communication agency 100 establishes communication with each of the vehicles 120 in the list provided by the service provider 130. The emergency communication agency 100 sends an emergency notification to each such vehicle 120. The emergency notification may comprise, for example, descriptions and/or images of the missing child, the suspect, and the suspect's vehicle such as color, make, model, and license plate number. The emergency communication may comprise a text message, a multimedia message, audio, and/or video, etc., depending on the services supported. The emergency communication may be displayed, for example, on the vehicle's navigation screen. In the present example, the emergency communication agency 100 sends a request for a photograph from the camera of the vehicle 120. In response, a photograph of a nearby car is taken by the camera of vehicle 120 and is sent to the emergency communication agency 100.

Image recognition algorithms may be used to determine the existence of a match between an image taken by the vehicle 120 and an image provided in the emergency notification. For example, an image of a car captured by the camera may be compared to an image of the suspect's or missing person's vehicle, in order to determine whether a match in the make and model exists. In addition, license plate recognition algorithms may be used to identify license plate numbers captured by the vehicle camera and compare them to a license plate number provided in the emergency notification. Furthermore, facial recognition algorithms may be used to compare images of faces captured by the vehicle camera to an image of the suspect or missing person provided in the emergency notification. Further still, voice recognition algorithms may be used to compare voice data captured by one or more vehicle microphones to a voice profile of a suspect or missing person.

If a match is found, the response from the vehicle 120 to the emergency communication agency 100 may include a report of the existence of a match. Alternatively, the image recognition algorithms and/or voice recognition algorithms may be performed by using a software program running on a computer of the emergency communication agency 100.

If a match is found, the emergency communication agency 100 may also send a request to the vehicle 120 for its current location as well as streaming video. In response, the vehicle 120 may send its current location, such as its GPS location, and a video stream. Furthermore, the emergency communication sender may be allowed to take control of the vehicle cameras, which may be limited to periods when the cameras are dormant, i.e., not in use. The data and video provided by the vehicle 120 may be forwarded to local police to facilitate the recovery of the missing child and apprehension of the suspect.

Although the foregoing example has been described in connection with an AMBER Alert, the principles of the present invention find application in many other types of emergency situations. For example, the systems and methods of the present invention may be used to disseminate emergency weather information, including instructions regarding evacuation routes. Susbcribers' cameras and microphones may be used to provide real-time audio, video and images of severe weather events such as hurricanes, tornadoes, etc. In addition, the systems and methods of the present invention may be used to disseminate terrorist advisories and instructions in the event of a terrorist attack. Subscribers' cameras and microphones may be used to quickly and effectively assist authorities in searching for terrorists, fugitives, and other suspected criminals.

It should be understood that the inventive concepts disclosed herein are capable of many other modifications. To the extent such modifications fall within the scope of the appended claims and their equivalents, they are intended to be covered by this patent. It should also be understood that the term “a” as used herein generally means “one or more” and is not intended to be construed in a singular sense. In addition, the operations described in connection with the methods of the present invention need not necessarily be executed in the sequence described, as they may be executed in a different sequence consistent with the principles of the present invention.

What is claimed is:

1. A method for two-way emergency communications, the method comprising:
identifying mobile communications devices that are located in a designated geographic area and that are capable of supporting a designated class of service;
wirelessly sending an emergency notification to the mobile communications devices that are located in the designated area; and
receiving a response from at least one of the mobile communications devices;
wherein the response comprises information obtained from an input device associated with the at least one mobile communications device.

2. The method of claim 1, wherein the mobile communications devices comprise an in-vehicle telematics unit coupled to one or more cameras and one or more microphones.

3. The method of claim 1, wherein the mobile communications devices comprise a mobile telephone.

4. The method of claim 1, wherein the response comprises a real-time location of the at least one mobile communications device.

5. The method of claim 1, wherein the information comprises audio.

6. The method of claim 5, further comprising the act of processing the audio using a voice recognition algorithm.

7. The method of claim 1, wherein the information comprises video.

8. The method of claim 1, wherein the information comprises an image.

9. The method of claim 8, further comprising the act of processing the image using an image recognition algorithm.

10. The method of claim 1, wherein the act of identifying mobile communications devices that are located in the designated geographic area comprises querying one or more service provider databases for current GPS location information.

11. The method of claim 1, further comprising the act of remotely controlling the input device associated with the at least one mobile communications device.

12. The method of claim 1, wherein the act of sending the emergency notification to the mobile communications devices that are located in the designated area comprises automatically broadcasting the emergency notification from one or more base transceiver stations located within the designated area.

13. A method for two-way emergency communications, the method comprising:
querying a database for all vehicles that are located in a designated geographic area and support a specified class of service;
receiving a list of vehicles that are located in the designated area and that support the specified class of service;
wirelessly sending an emergency notification to at least one of the vehicles in the list;
remotely controlling one or more input devices associated with the at least one of the vehicles; and
receiving information from the at least one of the vehicles.

14. The method of claim 13, wherein the information comprises a real-time location of the at least one of the vehicles.

15. The method of claim 13, wherein the information comprises audio received by the one or more input devices.

16. The method of claim 13, wherein the information comprises video received by the one or more input devices.

17. The method of claim 13, wherein the information comprises an image received by the one or more input devices.

18. A system for two-way emergency communications, the system comprising:
an emergency communication agency communicably coupled to a network;
a service provider communicably coupled to the network; and
a plurality of mobile communications devices communicably coupled to the network;
wherein the emergency communication agency is configured to automatically send an emergency notification to selected mobile communications devices that are located in a specified geographic area and support a specified class of service; and
wherein the selected mobile communications devices are configured to provide information to the emergency communication agency in response to the emergency notification; and
wherein the emergency communication agency or the service provider is configured to remotely control one or more input devices associated with the selected mobile communications devices.

19. The system of claim 18, wherein the mobile communications devices comprise an in-vehicle telematics unit coupled to one or more cameras and one or more microphones.

20. The system of claim 18, wherein the mobile communications devices comprise a mobile telephone.
